(19) United States
(12) Patent Application Publication
(10) Pub. No.: US 2014/0103711 A1
(43) Pub. Date: Apr. 17, 2014

(54) CONTACTLESS POWER RECEIVING DEVICE, VEHICLE EQUIPPED WITH THE SAME, CONTACTLESS POWER TRANSMITTING DEVICE, AND CONTACTLESS POWER TRANSFER SYSTEM

(71) Applicants: Shinji Ichikawa, Toyota-shi (JP); Hiroyuki Sakakibara, Hekinan-shi (JP)

(72) Inventors: Shinji Ichikawa, Toyota-shi (JP); Hiroyuki Sakakibara, Hekinan-shi (JP)

(73) Assignee: TOYOTA JIDOSHA KABUSHIKI KAISHA, Toyota-shi, Aichi-ken (JP)

(21) Appl. No.: 14/123,527

(22) PCT Filed: Jun. 4, 2012
(86) PCT No.: PCT/IB2012/001074

§ 371 Date: Dec. 3, 2013

(30) Foreign Application Priority Data
Jun. 9, 2011 (JP) 2011-129081

(51) Int. Cl. H01F 38/14

(52) U.S. Cl. CPC H01F 38/14
USPC 307/10.1; 307/104

(57) ABSTRACT

A resonance coil of a vehicle resonates with a resonance coil of a power transmitting device via an electromagnetic field to thereby receive alternating-current power output from the resonance coil in a noncontact manner. An inverter receives the alternating-current power, received by the resonance coil, from an electromagnetic induction coil, converts the alternating-current power to direct-current power and outputs the direct-current power to a power line. In addition, the inverter converts direct-current power, received from the power line, to alternating-current power and outputs the alternating-current power to the electromagnetic induction coil in order to output electric power from the resonance coil to the resonance coil of the power transmitting device, and electric power is supplied to the resonance coil by the electromagnetic induction coil.

### BACKGROUND OF THE INVENTION

1. Field of the Invention

The invention relates to a contactless power receiving device, a vehicle equipped with the same, a contactless power transmitting device and a contactless power transfer system and, more particularly, to a technique for transferring electric power through resonance of a pair of resonators via an electromagnetic field in a noncontact manner.

2. Description of Related Art

Wireless power transfer that does not use a power cord or a power transmission cable becomes a focus of attention. Three leading techniques are known as the wireless power transfer technique. The three leading techniques are power transfer using electromagnetic induction, power transfer using a microwave and power transfer using a resonance method.

The resonance method is a contactless power transfer technique such that a pair of resonators (for example, a pair of resonance coils) are resonated in an electromagnetic field (near field) to thereby transmit electric power via the electromagnetic field. The resonance method is able to transmit large electric power of several kilowatts over a relatively long distance (for example, several meters).

International Application Publication No. WO2010/35321 describes a power supply system that supplies electric power from a power supply device outside a vehicle to an electric vehicle using a resonance method in a noncontact manner. In this power supply system, a primary self-resonance coil of the power supply device and a secondary self-resonance coil of the electric vehicle resonate with each other via an electromagnetic field to thereby supply electric power from the power supply device to the electric vehicle in a noncontact manner. Electric power received by the secondary self-resonance coil is rectified by a rectifier, the voltage of the electric power is converted by a DC/DC converter, and then the electric power is supplied to an electrical storage device. In addition, other than WO2010/35321, Japanese Patent Application Publication No. 2008-289273 (JP 2008-289273 A), Japanese Patent Application Publication No. 2005-210843 (JP 2005-210843 A), International Application Publication No. WO2010/131346 and Japanese Patent Application Publication No. 2010-183813 (JP 2010-183813 A) also describe related arts of the invention.

The power supply system described in WO2010/35321 is useful in terms of being able to supply electric power from a power supply facility outside the vehicle to the electric vehicle with high efficiency using a resonance method; however, the mechanism of outputting electric power from the electric vehicle to the outside of the vehicle is not particularly studied.

In a system that supplies electric power from a power transmitting device (power supply facility) to a power receiving device (vehicle, or the like) with high efficiency using a resonance method, if electric power may be output from the power receiving device (vehicle, or the like) to the power transmitting device or an electric load that includes a resonator, the vehicle, or the like, may be, for example, utilized as an emergency power supply in the event of emergency or disaster.

### SUMMARY OF THE INVENTION

The invention provides a contactless power receiving device, vehicle equipped with the same, contactless power transmitting device and contactless power transfer system that are able to bidirectionally transfer electric power using a resonance method.

An aspect of the invention provides a contactless power receiving device that receives electric power output from a power transmitting device in a noncontact manner. The contactless power receiving device includes a power receiving resonator and an inverter. The power receiving resonator resonates with a power transmitting resonator of the power transmitting device via an electromagnetic field to thereby receive alternating-current power output from the power transmitting resonator in a noncontact manner. The inverter converts the alternating-current power, received by the power receiving resonator, to direct-current power and outputs the direct-current power to a power line, and converts direct-current power, received from the power line to alternating-current power and outputs the alternating-current power to the power receiving resonator in order to output electric power from the power receiving resonator to an outside.

In addition, the contactless power receiving device may further include a direct-current power supply and a converter. The converter is connected between the direct-current power supply and the power line and adjusts a voltage of the power line.

Furthermore, the contactless power receiving device may be mounted on an electric vehicle that is able to travel using an electric motor. The converter is a drive converter that is provided between the direct-current power supply and a driving device of the electric motor. Then, the contactless power receiving device further includes a connection device. The connection device is used to electrically connect the drive converter to the power line when electric power is output from the power receiving resonator.

In addition, the contactless power receiving device may further include a control unit. The control unit detects a mismatch between the power transmitting resonator and the power receiving resonator on the basis of a transfer condition of electric power between the power transmitting resonator and the power receiving resonator, and drives the inverter and the converter when the mismatch falls within a predetermined range set on the basis of the transfer condition.

Furthermore, the control unit may control the inverter and the converter on the basis of an amount of the mismatch between the power transmitting resonator and the power receiving resonator.

In addition, the contactless power receiving device may further include a control unit. The control unit detects a mismatch between the power transmitting resonator and the power receiving resonator on the basis of a transfer condition of electric power between the power transmitting resonator and the power receiving resonator, and drives the inverter when the mismatch falls within a predetermined range set on the basis of the transfer condition.

Another aspect of the invention provides a vehicle that includes any one of the above described contactless power receiving devices.

Further another aspect of the invention provides a contactless power transmitting device that outputs electric power to a power receiving device in a noncontact manner. The contactless power transmitting device includes a power supply unit, a power transmitting resonator, and a resistive circuit. The power supply unit generates alternating-current power having a predetermined frequency. The power transmitting resonator resonates with a power receiving resonator of the power receiving device via an electromagnetic field to thereby output the alternating-current power, supplied from the power supply unit, to the power receiving resonator in a noncontact manner. The resistive circuit is provided between a pair of power lines connected between the power supply unit and the power transmitting resonator, and is electrically connected between the pair of power lines at the time of detection of a mismatch between the power transmitting resonator and the power receiving resonator, the detection of the mismatch being carried out when the power transmitting resonator receives electric power output from the power receiving resonator.

In addition, the resistive circuit may include a resistor having a set resistance value and a relay. The relay is connected in series with the resistor, and enters an electrically conductive state at the time of detection of the mismatch.

Yet further another aspect of the invention provides a contactless power transfer system that transfers electric power from a power transmitting device to a power receiving device in a noncontact manner. The power transmitting device includes a power supply unit and a power transmitting resonator. The power supply unit generates alternating-current power having a predetermined frequency. The power transmitting resonator outputs the alternating-current power, supplied from the power supply unit, to the power receiving device in a noncontact manner. The power receiving device includes a power receiving resonator and an inverter. The power receiving resonator resonates with the power transmitting resonator via an electromagnetic field to thereby receive the alternating-current power output from the power transmitting resonator in a noncontact manner. The inverter converts the alternating-current power, received by the power receiving resonator, to direct-current power and outputs the direct-current power to a power line, and converts direct-current power, received from the power line to alternating-current power and outputs the alternating-current power to the power receiving resonator in order to output electric power from the power receiving resonator to an outside.

In addition, the power receiving device may further include a direct-current power supply and a converter. The converter is connected between the direct-current power supply and the power line, and is configured to adjust a voltage of the power line.

Furthermore, the power receiving device may be mounted on an electric vehicle that is able to travel using an electric motor. The converter is a drive converter that is provided between the direct-current power supply and a driving device of the electric motor. The power receiving device further includes a connection device. The connection device is used to electrically connect the drive converter to the power line when electric power is output from the power receiving resonator.

In addition, the power transmitting device may further include a resistive circuit. The resistive circuit is provided between a pair of power lines connected between the power supply unit and the power transmitting resonator, and is electrically connected between the pair of power lines at the time of detection of a mismatch between the power transmitting resonator and the power receiving resonator, the detection of the mismatch being carried out when the power transmitting resonator receives electric power output from the power receiving resonator.

Furthermore, the resistive circuit may include a resistor having a set resistance value and a relay. The relay is connected in series with the resistor, and enters an electrically conductive state at the time of detection of the mismatch.

With the above described contactless power receiving device, contactless power transmitting device and contactless power transfer system, the inverter that is able to bidirectionally convert electric power is provided between the power receiving resonator and the power line in the power receiving device, so alternating-current power received by the power receiving resonator may be converted to direct-current power and then output to the power line, and direct-current power received from the power line may be converted to alternating-current power and then electric power may be output from the power receiving resonator to an outside. Thus, according to the aspects of the invention, it is possible to bidirectionally transfer electric power in the contactless power transfer system that uses a resonance method.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall configuration diagram of a contactless power transfer system according to a first embodiment of the invention;

FIG. 2 is a view for illustrating the principle of power transfer using a resonance method according to the first embodiment;

FIG. 3 is a functional block diagram of an ECU of a power transmitting device shown in FIG. 1;

FIG. 4 is a functional block diagram of an ECU of a vehicle shown in FIG. 1;

FIG. 5 is a flow chart for illustrating the procedure associated with power transfer between the power transmitting device and the vehicle according to the first embodiment;

FIG. 6 is an overall configuration diagram of a contactless power transfer system according to a second embodiment;

FIG. 7 is a flow chart for illustrating the procedure associated with power transfer between a power transmitting device and a vehicle according to the second embodiment; and

FIG. 8 is an overall configuration diagram of a contactless power transfer system according to a third embodiment.

### DETAILED DESCRIPTION OF EMBODIMENTS

Hereinafter, first to third embodiments of the invention will be described in detail with reference to the accompanying drawings. Note that like reference numerals denote the same or corresponding components in the drawings, and the description thereof is not repeated.

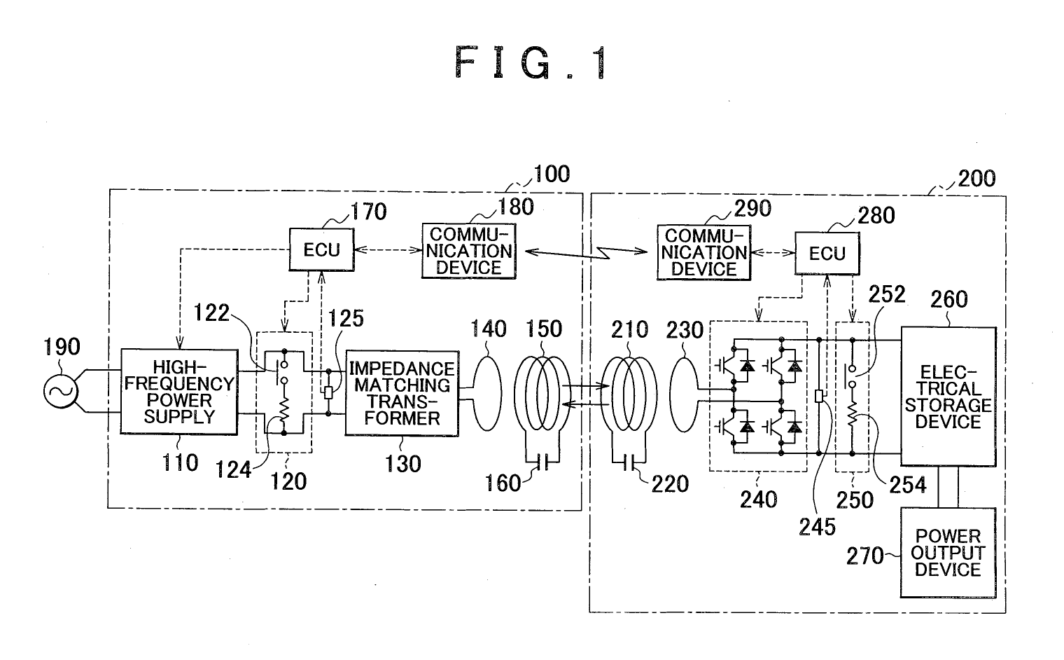

The first embodiment of the invention will be described. FIG. 1 is an overall configuration diagram of a contactless power transfer system according to the first embodiment of the invention. As shown in FIG. 1, the contactless power transfer system includes a power transmitting device 100 and a vehicle 200 that serves as a power receiving device.

The power transmitting device 100 includes a power supply unit 110, a resistive circuit 120, a voltage sensor 125, an impedance matching transformer 130, an electromagnetic induction coil 140, a resonance coil 150, a capacitor 160, an electronic control unit (hereinafter, referred to as “ECU”) 170 and a communication device 180.

The power supply unit 110 receives electric power from a system power supply 190 to generate high-frequency alternating-current power. The frequency of the generated alternating-current power is, for example, about 1 MHz to several tens of MHz. The power supply unit 110 generates and stops the above alternating-current power and controls output power in accordance with a command from the ECU 170.

The resistive circuit 120 includes a relay 122 and a resistor 124. The relay 122 and the resistor 124 are serially connected between a pair of power lines arranged between the power supply unit 110 and the impedance matching transformer 130. The relay 122 is controlled by the ECU 170. The resistor 124 has a set resistance value.

In this contactless power transfer system, electric power may be transmitted from the power transmitting device 100 to the vehicle 200, and electric power may also be transmitted from the vehicle 200 to the power transmitting device 100. Then, the resistive circuit 120 is used to detect a mismatch between the resonance coils 150 and 210 when electric power is transmitted from the vehicle 200 to the power transmitting device 100. That is, because the relay 122 is turned on at the time of detecting the mismatch, an impedance at the time when a predetermined regulating electric power (set electric power) is output from the vehicle 200 to the power transmitting device 100 may be constantly kept constant, so the mismatch between the resonance coils 150 and 210 may be detected from a receiving voltage, or the like, detected by the voltage sensor 125.

The voltage sensor 125 is provided adjacent to the resonance coil 150 with respect to the resistive circuit 120, and is, for example, provided between the resistive circuit 120 and the impedance matching transformer 130. The voltage sensor 125 detects the receiving voltage in the, power transmitting device 100 and outputs the receiving voltage to the ECU 170 when electric power is transmitted from the vehicle 200 to the power transmitting device 100.

The impedance matching transformer 130 is provided between the power supply unit 110 and the electromagnetic induction coil 140, and is configured to be able to vary the impedance inside. The impedance matching transformer 130 varies the impedance in accordance with a command from the ECU 170 to match the impedance of a resonance system with the impedance of the power supply unit 110. The resonance system includes the electromagnetic induction coil 140, the resonance coil 150, the capacitor 160, and the resonance coil 210, capacitor 220 and electromagnetic induction coil 230 of the vehicle 200. Note that the impedance matching transformer 130 is, for example, formed of a variable capacitor and a coil.

The electromagnetic induction coil 140 is able to be magnetically coupled to the resonance coil 150 through electromagnetic induction coupling, and supplies alternating-current power, generated by the power supply unit 110, to the resonance coil 150 when electric power is transmitted from the power transmitting device 100 to the vehicle 200. On the other hand, when electric power is transmitted from the vehicle 200 to the power transmitting device 100, the electromagnetic induction coil 140 extracts electric power, received by the resonance coil 150, through electromagnetic induction, and outputs the extracted electric power.

The resonance coil 150 is configured to be able to transfer electric power between the resonance coils 150 and 210 by resonating with the resonance coil 210, mounted on the vehicle 200, via an electromagnetic field. When electric power is transmitted from the power transmitting device 100 to the vehicle 200, the resonance coil 150 transfers alternating-current power, supplied from the electromagnetic induction coil 140, to the resonance coil 210 of the vehicle 200, which resonates with the resonance coil 150. When electric power is transmitted from the vehicle 200 to the power transmitting device 100, the resonance coil 150 receives electric power transmitted from the resonance coil 210 that resonates with the resonance coil 150. The capacitor 160 is to adjust the resonance frequency of the resonance coil 150, and is, for example, connected between both end portions of the resonance coil 150.

Note that the coil diameter and number of turns of the resonance coil 150 are appropriately set such that the Q value increases (for example, Q>100) and the degree of coupling κ decreases on the basis of the distance from the resonance coil 210 of the vehicle 200, the power transmitting frequency, and the like. Note that this power transfer through resonance is a power transfer technique different from electromagnetic induction that is designed such that the Q value reduces and the degree of coupling κ increases.

Note that the electromagnetic induction coil 140 is provided in order to make it easy to supply electric power from the power supply unit 110 to the resonance coil 150 and extract electric power from the resonance coil 150, and it may be configured without the electromagnetic induction coil 140. In addition, it may be configured such that the stray capacitance of the resonance coil 150 is utilized and no capacitor 160 is provided.

The ECU 170 controls power transmission from the power transmitting device 100 to the vehicle 200 through software processing implemented by executing a prestored program on a central processing unit (CPU) (not shown) and/or hardware processing using an exclusive electronic circuit. In addition, when electric power is transmitted from the vehicle 200 to the power transmitting device 100, the ECU 170 turns on the relay 122 of the resistive circuit 120, and detects the mismatch between the resonance coils 150 and 210 on the basis of the voltage detected by the voltage sensor 125 when regulating electric power is output from the vehicle 200 to the power transmitting device 100. In addition, the ECU 170 controls communication with the vehicle 200 using the communication device 180 in order to exchange information (start/stop of power transmission, transmitting power, receiving power, receiving voltage, and the like), required to transfer electric power between the power transmitting device 100 and the vehicle 200, with the vehicle 200. The communication device 180 is a communication interface for carrying out wireless communication with the vehicle 200.

On the other hand, the vehicle 200 includes the resonance coil 210, the capacitor 220, the electromagnetic induction coil 230, an inverter 240, a voltage sensor 245, a resistive circuit 250, an electrical storage device 260, a power output device 270, an ECU 280 and a communication device 290.

The resonance coil 210 is configured to be able to transfer electric power between the resonance coils 150 and 210 by resonating with the resonance coil 150 of the power transmitting device 100 via an electromagnetic field. When electric power is transmitted from the power transmitting device 100 to the vehicle 200, the resonance coil 210 receives electric power transmitted from the resonance coil 150 that resonates with the resonance coil 210 with each other. When electric power is transmitted from the vehicle 200 to the power transmitting device 100, the resonance coil 210 transfers alternating-current power, supplied from the electromagnetic induction coil 230, to the resonance coil 210 that resonates with the resonance coil 150. The capacitor 220 is to adjust the resonance frequency of the resonance coil 210, and is, for example, connected between both end portions of the resonance coil 210.

Note that the coil diameter and number of turns of the resonance coil 210 are appropriately set such that the Q value increases and the degree of coupling κ decreases on the basis of the distance from the resonance coil 150 of the power transmitting device 100, the power transmitting frequency, and the like.

The electromagnetic induction coil 230 is able to be magnetically coupled to the resonance coil 210 through electromagnetic induction coupling, and extracts electric power, received by the resonance coil 210, through electromagnetic induction and outputs the extracted electric power to the inverter 240 when electric power is transmitted from the power transmitting device 100 to the vehicle 200. On the other hand, when electric power is transmitted from the vehicle 200 to the power transmitting device 100, the electromagnetic induction coil 230 supplies alternating-current power, output from the inverter 240, to the resonance coil 210.

Note that the electromagnetic induction coil 230 is also provided in order to make it easy to extract electric power from the resonance coil 210 and supply electric power from the inverter 240 to the resonance coil 210, and it may be configured without the electromagnetic induction coil 230. In addition, it may be configured such that the stray capacitance of the resonance coil 210 is utilized and no capacitor 220 is provided.

The inverter 240 converts alternating-current power, extracted by the electromagnetic induction coil 230, to direct-current power, and outputs the direct-current power to the electrical storage device 260. On the other hand, when electric power is transmitted from the vehicle 200 to the power transmitting device 100, the inverter 240 converts direct-current power, supplied from the electrical storage device 260 or the power output device 270, to high-frequency alternating-current power, and outputs the high-frequency alternating-current power to the electromagnetic induction coil 230. The frequency of alternating-current power generated by the inverter 240 is equivalent to the frequency of alternating-current power generated by the power supply unit 110 of the power transmitting device 100 at the time when electric power is transmitted from the power transmitting device 100 to the vehicle 200, and is, for example, about 1 MHz to several tens of MHz.

The voltage sensor 245 is provided adjacent to the resonance coil 210 with respect to the resistive circuit 250, and is, for example, provided between the inverter 240 and the resistive circuit 250. The voltage sensor 245 detects the receiving voltage in the vehicle 200 and outputs the receiving voltage to the ECU 280 when electric power is transmitted from the power transmitting device 100 to the vehicle 200.

The resistive circuit 250 includes a relay 252 and a resistor 254. The relay 252 and the resistor 254 are serially connected between a pair of power lines arranged between the inverter 240 and the electrical storage device 260. The relay 252 is controlled by the ECU 280. The resistor 254 has a set resistance value. The resistive circuit 250 is used to detect the mismatch between the resonance coils 150 and 210. That is, because the relay 252 is turned on, an impedance at the time when a predetermined regulating electric power (set electric power) is output from the power transmitting device 100 to the vehicle 200 may be constantly kept constant, so the mismatch between the resonance coils 150 and 210 may be detected from a receiving voltage, or the like, detected by the voltage sensor 245.

The electrical storage device 260 is a rechargeable direct-current power supply, and is, for example, formed of a secondary battery, such as a lithium ion battery and a nickel metal hydride battery. The electrical storage device 260 not only stores electric power output from the inverter 240 but also stores electric power generated by the power output device 270. Then, the electrical storage device 260 supplies the stored electric power to the power output device 270. In addition, when electric power is transmitted from the vehicle 200 to the power transmitting device 100, the electrical storage device 260 supplies electric power to the inverter 240. Note that a large-capacitance capacitor may be employed as the electrical storage device 260.

The power output device 270 uses electric power stored in the electrical storage device 260 to generate driving force for propelling the vehicle 200. Although not specifically shown, the power output device 270, for example, includes an inverter that receives electric power from the electrical storage device 260, a motor that is driven by the inverter, drive wheels that are driven by the motor, and the like. Note that the power output device 270 may include a generator for charging the electrical storage device 260 and an engine that is able to drive the generator.

The ECU 280 controls power reception from the power transmitting device 100 through software processing implemented by executing a prestored program on a CPU (not shown) and/or hardware processing using an exclusive electronic circuit. In addition, the ECU 280 turns on the relay 252 of the resistive circuit 250 to detect the mismatch between the resonance coils 150 and 210 on the basis of the voltage detected by the voltage sensor 245 when regulating electric power is output from the power transmitting device 100 to the vehicle 200. In addition, the ECU 280 controls communication with the power transmitting device 100 using the communication device 290 in order to exchange information, required to transfer electric power between the power transmitting device 100 and the vehicle 200, with the power transmitting device 100. The communication device 290 is a communication interface for carrying out wireless communication with the power transmitting device 100.

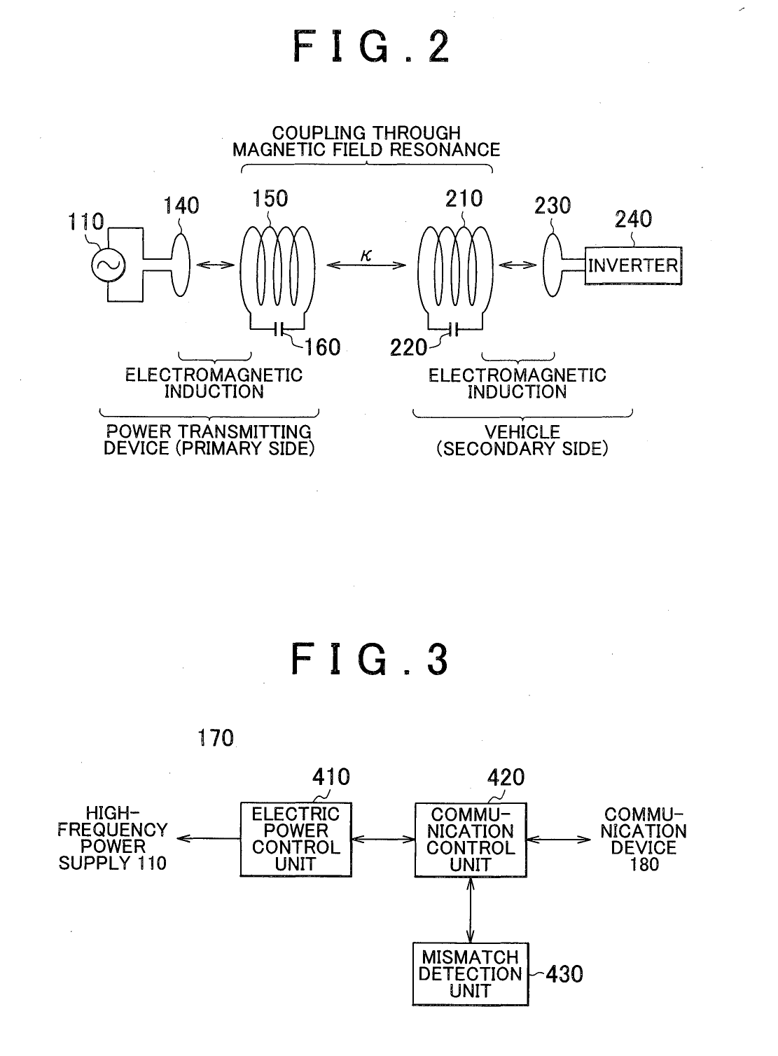

FIG. 2 is a view for illustrating the principle of power transfer using a resonance method. Referring to FIG. 2, in the resonance method, as in the case where two tuning forks resonate with each other, two LC resonance coils (resonance coils 150 and 210) having the same natural frequency resonate with each other in an electromagnetic field (near field) to thereby transfer electric power from one of the resonance coils to the other one of the resonance coils.

Specifically, the electromagnetic induction coil 140 connected to the power supply unit 110 is used to supply high-frequency electric power of 1 MHz to several tens of MHz to the resonance coil 150. The resonance coil 150 forms an LC resonator together with the capacitor 160, and resonates via an electromagnetic field (near field) with the resonance coil 210 having the same resonance frequency as the resonance coil 150. Then, energy (electric power) is transferred from the resonance coil 150 to the resonance coil 210 via the electromagnetic field. Energy (electric power) transferred to the resonance coil 210 is extracted using the electromagnetic induction coil 230. The extracted energy (electric power) is converted to direct-current power by the inverter 240, and is supplied to a load (not shown) on the downstream side.

Similarly, when electric power is transmitted from the vehicle 200 to the power transmitting device 100, high-frequency electric power of 1 MHz to several tens of MHz, output from the inverter 240, is supplied to the resonance coil 210 using the electromagnetic induction coil 230. Then, energy (electric power) is transferred from the resonance coil 210 to the resonance coil 150 via the electromagnetic field. Energy (electric power) transferred to the resonance coil 150 is extracted using the electromagnetic induction coil 140, and may be supplied to the power supply unit 110 or an electrical load (not shown).

Referring back to FIG. 1, in this contactless power transfer system, the resonance coil 150 of the power transmitting device 100 and the resonance coil 210 of the vehicle 200 are caused to resonate with each other via an electromagnetic field to thereby make it possible to transfer electric power from the power transmitting device 100 to the vehicle 200 in a noncontact manner. The vehicle 200 includes the inverter 240, and electric power received by the resonance coil 210 is converted to direct-current power by the inverter 240 and is output to the electrical storage device 260.

The vehicle 200 includes the resistive circuit 250 for detecting the mismatch between the resonance coils 150 and 210. The relay 252 of the resistive circuit 250 is turned on to detect the mismatch between the resonance coils 150 and 210 from the receiving voltage of the vehicle 200, or the like, when regulating electric power is output from the power transmitting device 100 to the vehicle 200.

In addition, in this contactless power transfer system, the resonance coils 150 and 210 are caused to resonate with each other to thereby make it possible to transfer electric power from the vehicle 200 to the power transmitting device 100 in a noncontact manner. The inverter 240 of the vehicle 200 is able to bidirectionally convert electric power, and is able to convert direct-current power, supplied from the electrical storage device 260 or the power output device 270, to high-frequency alternating-current power, by which the resonance coils 150 and 210 resonate with each other, and supply the high-frequency alternating-current power to the resonance coil 210. Then, as alternating-current power is supplied from the inverter 240 to the resonance coil 210 using the electromagnetic induction coil 230, the resonance coils 150 and 210 resonate with each other via an electromagnetic field, and electric power is transferred from the resonance coil 210 to the resonance coil 150 of the power transmitting device 100.

Here, the power transmitting device 100 also includes the resistive circuit 120 for detecting the mismatch between the resonance coils 150 and 210 when electric power is transmitted from the vehicle 200 to the power transmitting device 100. The relay 122 of the resistive circuit 120 is turned on to detect the mismatch between the resonance coils 150 and 210 from the receiving voltage of the power transmitting device 100, or the like, when regulating electric power is output from the vehicle 200 to the power transmitting device 100.

FIG. 3 is a functional block diagram of the power transmitting device 100 shown in FIG. 1. As shown in FIG. 3, the ECU 170 includes an electric power control unit 410, a communication control unit 420 and a mismatch detection unit 430.

The electric power control unit 410 controls the power supply unit 110 to control electric power transmitted to the vehicle 200 when electric power is transmitted from the power transmitting device 100 to the vehicle 200. Here, at the time of detecting the mismatch between the resonance coils 150 and 210, the electric power control unit 410 controls the power supply unit 110 so as to output an electric power (regulating electric power) smaller than that when electric power is regularly transmitted in order to charge the electrical storage device 260.

The communication control unit 420 controls communication with the vehicle 200 using the communication device 180. As an example, the communication control unit 420 controls the communication device 180 so as to transmit information about start/stop transmission of electric power to the vehicle 200, the magnitude of electric power transmitted to the vehicle 200, start/stop of the process of detecting the mismatch between the resonance coils 150 and 210, and the like, to the vehicle 200. In addition, as an example, the communication control unit 420 controls the communication device 180 so as to receive information about the receiving power or receiving voltage of the vehicle 200, electric power output from the vehicle 200 when electric power is transmitted from the vehicle 200 to the power transmitting device 100, and the like, from the vehicle 200.

The mismatch detection unit 430 detects the mismatch between the resonance coils 150 and 210. Specifically, when electric power is transmitted from the, power transmitting device 100 to the vehicle 200, the relay 252 of the resistive circuit 250 is turned on in the vehicle 200, and the mismatch detection unit 430 uses a prepared map, or the like, that indicates the correlation between a receiving condition (receiving voltage, receiving power, or the like) of the vehicle 200 and a mismatch between the resonance coils 150 and 210 in a situation that regulating electric power is output to thereby detect the mismatch between the resonance coils 150 and 210 on the basis of the receiving condition of the vehicle 200.

In addition, when electric power is transmitted from the vehicle 200 to the power transmitting device 100, the mismatch detection unit 430 turns on the relay 122 of the resistive circuit 120, and uses a prepared map, or the like, that indicates the correlation between a receiving condition (receiving voltage, receiving power, or the like) of the power transmitting device 100 and a mismatch between the resonance coils 150 and 210 in a situation that regulating electric power is output from the vehicle 200 to thereby detect the mismatch between the resonance coils 150 and 210 on the basis of the receiving condition of the power transmitting device 100. Note that the result of mismatch detection is transmitted to the vehicle 200 by the communication control unit 420.

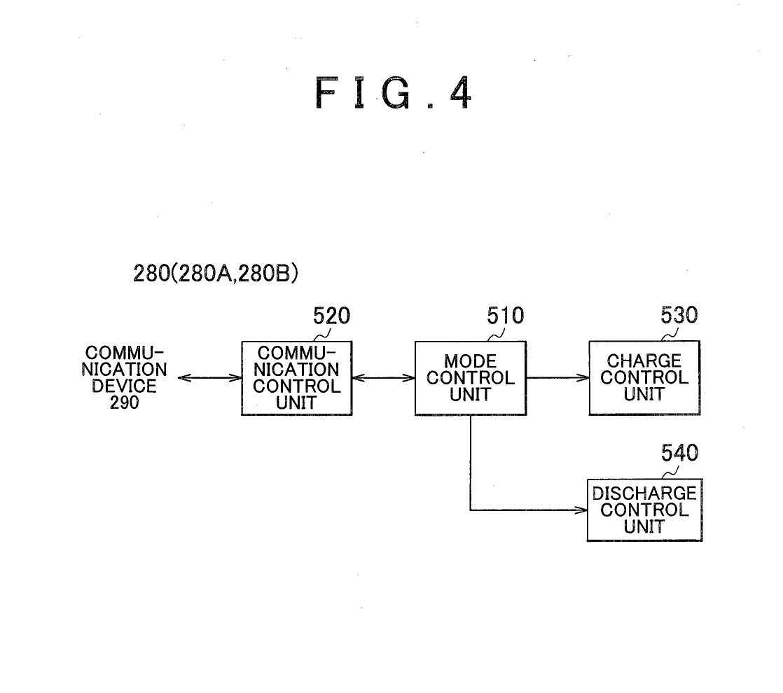

FIG. 4 is a functional block diagram of the ECU 280 of the vehicle 200 shown in FIG. 1. As shown in FIG. 4, the ECU 280 includes a mode control unit 510, a communication control unit 520, a charge control unit 530 and a discharge control unit 540.

When a request to transmit electric power from the power transmitting device 100 to the vehicle 200 is issued, the mode control unit 510 sets a power transfer mode in a “charge mode”; whereas, when a request to transmit electric power from the vehicle 200 to the power transmitting device 100 is issued, the mode control unit 510 sets the power transfer mode in a “discharge mode”. Then, the mode control unit 510 provides a notification to the charge control unit 530 in the case of the charge mode, whereas the mode control unit 510 provides a notification to the discharge control unit 540 in the case of the discharge mode. Note that whether the power transfer mode is the charge mode or discharge mode is transmitted to the power transmitting device 100 by the communication control unit 520.

The communication control unit 520 controls communication with the power transmitting device 100 using the communication device 290. As an example, the communication control unit 520 controls the communication device 290 so as to transmit the power transfer mode of the vehicle 200 and information about start/stop transmission of electric power from the vehicle 200, receiving power or receiving voltage of the vehicle 200 in the charge mode, electric power output from the vehicle 200 in the discharge mode, and the like, to the outside of the vehicle. In addition, as an example, the communication control unit 520 controls the communication device 290 so as to receive information about start/stop transmission of electric power from the power transmitting device 100, the magnitude of electric power output from the power transmitting device 100, start/stop of the process of detecting the mismatch between the resonance coils 150 and 210, a detected result of the mismatch, and the like, from the power transmitting device 100.

When the charge control unit 530 has received from the mode control unit a notification that the power transfer mode is the charge mode, the charge control unit 530 controls the vehicle 200 so as to be operated as a power receiving device. Specifically, the charge control unit 530 generates a driving signal for operating the inverter 240 so as to convert alternating-current power, received by the resonance coil 210, to direct-current power, and outputs the generated driving signal to the inverter 240. In addition, the charge control unit 530 turns on the relay 252 of the resistive circuit 250 at the time of detecting the mismatch between the resonance coils 150 and 210 in the case where electric power is transmitted from the power transmitting device 100 to the vehicle 200.

When the discharge control unit 540 has received from the mode control unit a notification that the power transfer mode is the discharge mode, the discharge control unit 540 controls the vehicle 200 so as to output electric power from the resonance coil 210. Specifically, the discharge control unit 540 generates a driving signal for operating the inverter 240 so as to convert direct-current power, supplied from the electrical storage device 260 or the power output device 270, to high-frequency alternating-current power, and outputs the generated driving signal to the inverter 240. In addition, the discharge control unit 540 controls the inverter 240 to control electric power output from the vehicle 200. Here, at the time of detecting the mismatch between the resonance coils 150 and 210, the discharge control unit 540 controls the inverter 240 so as to output a predetermined regulating electric power.

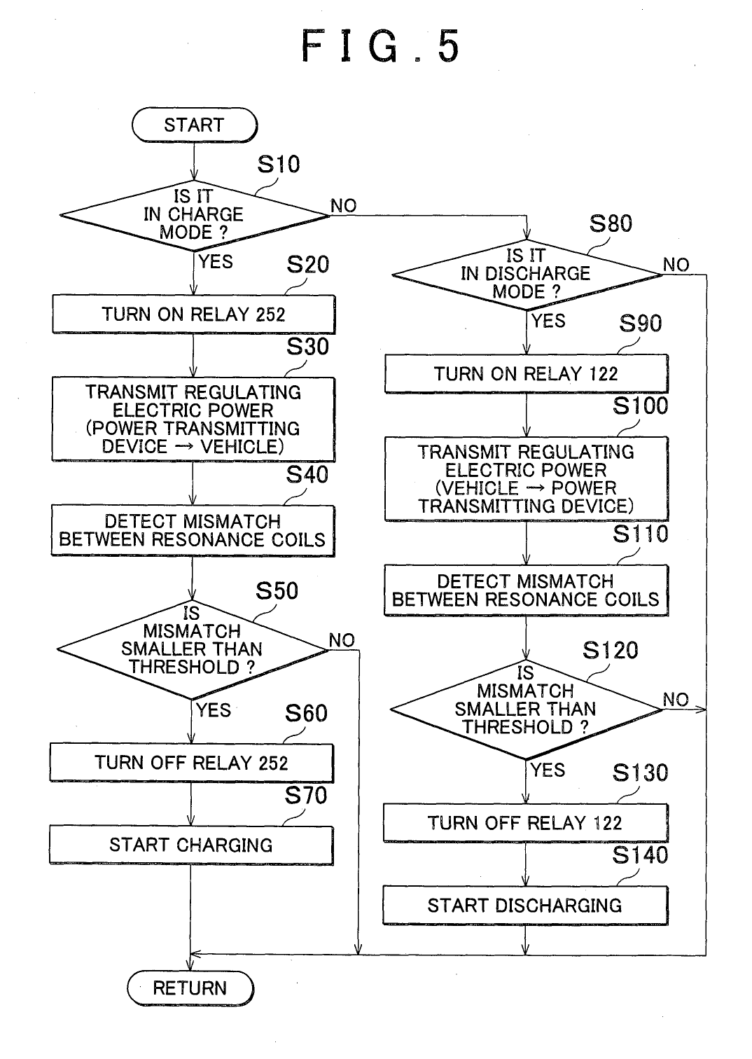

FIG. 5 is a flow chart for illustrating the procedure associated with power transfer between the power transmitting device 100 and the vehicle 200. As shown in FIG. 1 together with FIG. 5, the ECU 280 of the vehicle 200 determines whether the power transfer mode is the charge mode (step S10). When it is determined that the power transfer mode is the charge mode (YES in step S10), the ECU 280 turns on the relay 252 of the resistive circuit 250 (step S20).

When the relay 252 is turned on, the ECU 170 of the power transmitting device 100 controls the power supply unit 110 so as to output regulating electric power from the power transmitting device 100 to the vehicle 200 (step S30). Then, the ECU 170 uses a prepared map, or the like, that indicates the correlation between a receiving condition of the vehicle 200 and a mismatch between the resonance coils 150 and 210 in a situation that regulating electric power is output to detect the mismatch between the resonance coils 150 and 210 on the basis of the receiving condition (for example, receiving voltage) of the vehicle 200 (step S40).

Subsequently, the ECU 170 determines whether the detected mismatch is smaller than or equal to a predetermined threshold (step S50). Note that the threshold is a value used to determine whether electric power is allowed to be transmitted from the power transmitting device 100 to the vehicle 200, and is preset on the basis of the transfer efficiency, or the like, of transmission of electric power from the power transmitting device 100 to the vehicle 200.

When it is determined in step S50 that the mismatch between the resonance coils 150 and 210 is smaller than the threshold (YES in step S50), a notification about the determination result is provided to the vehicle 200. Then, the ECU 280 of the vehicle 200 turns off the relay 252 (step S60). Then, when the relay 252 is turned off, the ECU 170 of the power transmitting device 100 controls the power supply unit 110 so as to regularly start transmission of electric power for charging the electrical storage device 260 of the vehicle 200, thus starting charging of the electrical storage device 260 (step S70). Note that when it is determined in step S50 that the mismatch is larger than or equal to the threshold (NO in step S50), the process proceeds to return.

On the other hand, when it is determined in step S10 that the power transfer mode is not the charge mode (NO in step S10), the ECU 280 determines whether the power transfer mode is the discharge mode (step S80). When it is determined that the power transfer mode is the discharge mode (YES in step S80), the ECU 170 turns on the relay 122 of the resistive circuit 120 in the power transmitting device 100 (step S90).

When the relay 122 is turned on, the ECU 280 of the vehicle 200 controls the inverter 240 so as to output regulating electric power from the vehicle 200 to the power transmitting device 100 (step S100). When output of regulating electric power is started, the ECU 170 of the power transmitting device 100 uses a prepared map, or the like, that indicates the correlation between a receiving condition of the power transmitting device 100 and a mismatch between the resonance coils 150 and 210 to detect the mismatch between the resonance coils 150 and 210 on the basis of the receiving condition (for example, receiving voltage) of the power transmitting device 100 (step S110).

Subsequently, the ECU 170 determines whether the detected mismatch is smaller than a predetermined threshold (step S120). Note that this threshold is also a value for determining whether electric power is allowed to be transmitted from the vehicle 200 to the power transmitting device 100, and is preset on the basis of the transfer efficiency, or the like, of transmission of electric power from the vehicle 200 to the power transmitting device 100.

When it is determined in step S120 that the mismatch between the resonance coils 150 and 210 is smaller than the threshold (YES in step S120), the ECU 170 turns off the relay 122 (step S130). Then, when the relay 122 is turned off, the ECU 280 of the vehicle 200 controls the inverter 240 so as to regularly start transmission of electric power from the vehicle 200 to the power transmitting device 100, thus starting discharging from the vehicle 200 (step S140). Note that, when it is determined in step S120 that the mismatch is larger than or equal to the threshold (NO in step S120), the process proceeds to return.

Note that, in the above description, for example, detection of the mismatch between the resonance coils 150 and 210 is carried out by the ECU 170 of the power transmitting device 100, and mode control is executed by the ECU 280 of the vehicle 200; however, allocation of the functions between the ECUs 170 and 280 is not limited to the above configuration. Communication may be carried out between the ECUs 170 and 280 using the communication devices 180 and 290, the functions of the ECU 170 may be implemented by the ECU 280, and the functions of the ECU 280 may be implemented by the ECU 170.

As described above, in this first embodiment, the inverter 240 that is able to bidirectionally convert electric power is provided in the vehicle 200, so, in the vehicle 200, alternating-current power, received by the resonance coil 210, may be converted to direct-current power and then output to the electrical storage device 260, and direct-current power received from the electrical storage device 260 may be converted to alternating-current power and then electric power may be output from the resonance coil 210 to the power transmitting device 100. Thus, according to the first embodiment, in the contactless power transfer system that uses a resonance method, power transfer may be carried out bidirectionally.

In addition, in this first embodiment, the resistive circuit 250 is provided for the vehicle 200 in order to detect the mismatch between the resistance coils 150 and 210 when electric power is transmitted from the power transmitting device 100 to the vehicle 200, the resistive circuit 120 is also provided for the power transmitting device 100 so as to be able to detect the mismatch between the resonance coils 150 and 210 when electric power is transmitted from the vehicle 200 to the power transmitting device 100. By so doing, when electric power is transmitted from the vehicle 200 to the power transmitting device 100, low-efficiency transmission of electric power in a state where the mismatch between the resonance coils 150 and 210 is large is prevented. Thus, according to the first embodiment, electric power may be transferred with high efficiency between the power transmitting device 100 and the vehicle 200.

Next, in a second embodiment, in order to implement further high-efficiency power transfer when electric power is transmitted from a vehicle to an outside, the output voltage of the electrical storage device 260 may be stepped up and then supplied to the inverter 240 in the vehicle. Here, a device for stepping up the output voltage of the electrical storage device 260 is a drive step-up converter provided in the power output device in this second embodiment.

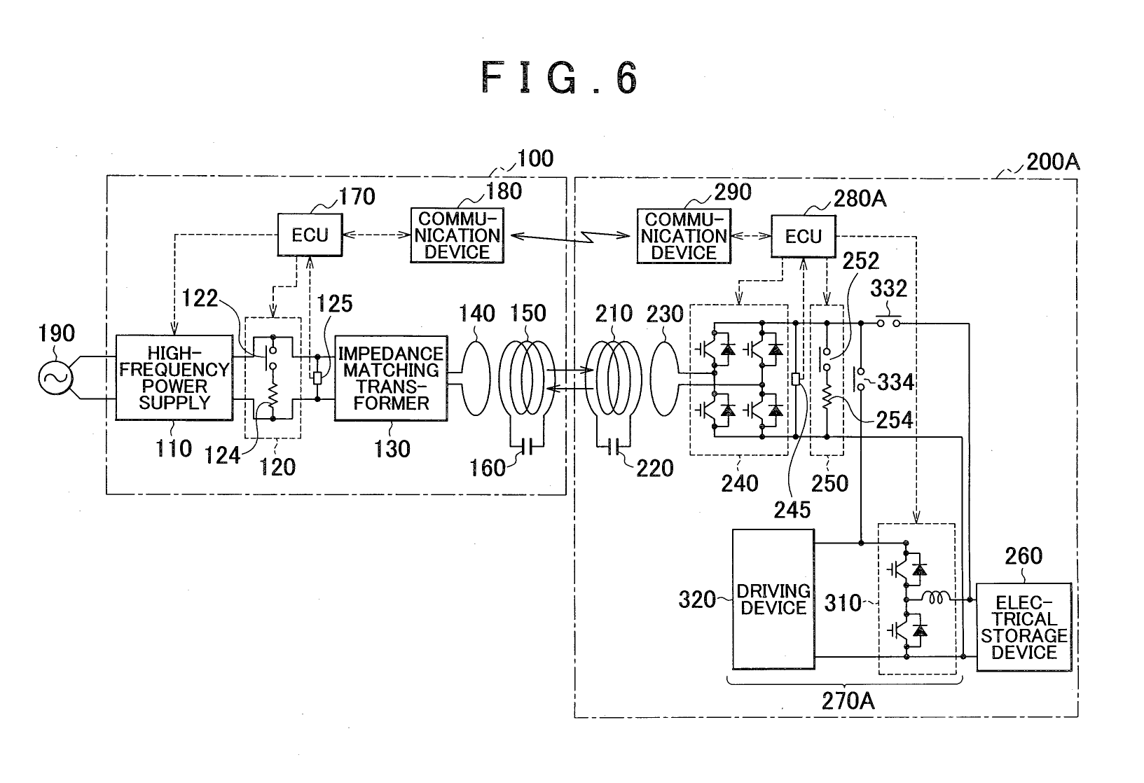

FIG. 6 is an overall configuration diagram of a contactless power transfer system according to the second embodiment. As shown in FIG. 6, a vehicle 200A in the contactless power transfer system differs from the vehicle 200 shown in FIG. 1 in that a power output device 270A and an ECU 280A are respectively replaced with the power output device 270 and the ECU 280 and relays 332 and 334 are further provided.

The power output device 270A includes a step-up converter 310 and a driving device 320. The step-up converter 310 is configured to be able to step up the output voltage of the electrical storage device 260 and output the stepped up voltage to the driving device 320. Here, when electric power is transmitted from the vehicle 200A to the power transmitting device 100, the step-up converter 310 is electrically connected to the inverter 240 by the relay 334, steps up direct-current power supplied from the electrical storage device 260 and supplies the stepped up direct-current power to the inverter 240. The step-up converter 310 is, for example, formed of a current reversible chopper circuit.

The driving device 320 uses electric power output from the step-up converter 310 to generate driving force for propelling the vehicle 200. Although not specifically shown, the driving device 320, for example, includes an inverter that receives electric power from the step-up converter 310, a motor that is driven by the inverter, drive wheels that are driven by the motor, and the like. Note that the driving device 320 may include a generator for charging the electrical storage device 260 and an engine that is able to drive the generator.

The relay 332 is provided in a power line between the resistive circuit 250 and the positive electrode of the electrical storage device 260. The relay 334 is provided in a power line for electrically connecting the step-up converter 310 to the inverter 240. Then, when electric power is transmitted from the power transmitting device 100 to the vehicle 200A (in the charge mode), the relay 332 is turned on and the relay 334 is turned off. On the other hand, when electric power is transmitted from the vehicle 200A to the power transmitting device 100 (in the discharge mode), the relay 332 is turned off and the relay 334 is turned on.

The ECU 280A controls operations of the relays 332 and 334. Specifically, in the charge mode, the ECU 280A turns on the relay 332 and turns off the relay 334. By so doing, in the charge mode, the inverter 240 is directly connected to the electrical storage device 260, and electric power converted by the inverter 240 into direct-current power is directly supplied to the electrical storage device 260.

On the other hand, in the discharge mode, the ECU 280A turns off the relay 332 and turns on the relay 334, and controls the step-up converter 310. By so doing, in the discharge mode, voltage stepped up by the step-up converter 310 is supplied to the inverter 240, and electric power converted by the inverter 240 into alternating-current power is supplied to the resonance coil 210 via the electromagnetic induction coil 230.

Note that the other functions of the ECU 280A are the same as those of the ECU 280 according to the first embodiment. In addition, the other configuration of the vehicle 200A is the same as that of the vehicle 200 according to the first embodiment.

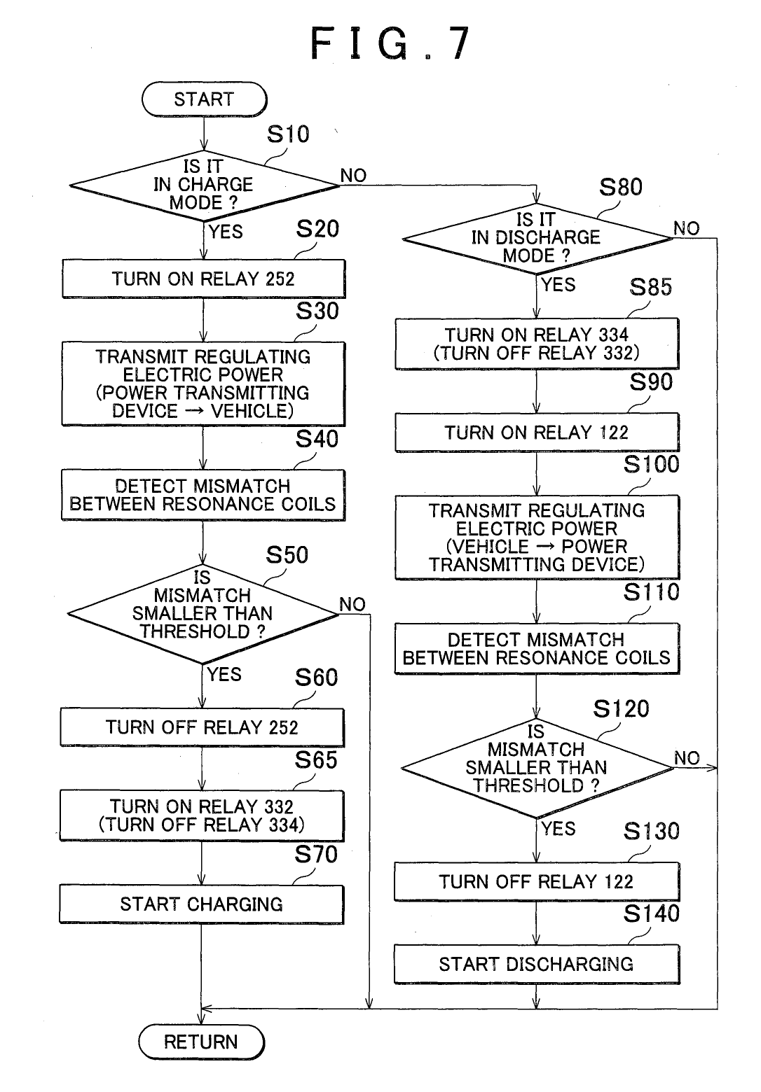

FIG. 7 is a flow chart for illustrating the procedure associated with power transfer between the power transmitting device 100 and the vehicle 200A according to the second embodiment. As shown in FIG. 6 together with FIG. 7, the flow chart further includes steps S65 and S85 with respect to the flow chart shown in FIG. 5.

That is, when the relay 252 of the vehicle 200A is turned off in step S60, the ECU 280A of the vehicle 200A turns on the relay 332 (step S65). Note that the relay 334 is turned off. Then, when the relay 332 is turned on, the inverter 240 is driven and electric power is directly supplied from the inverter 240 to the electrical storage device 260 in step S70.

In addition, when it is determined in step S80 that the power transfer mode is the discharge mode (YES in step S80), the ECU 280A turns on the relay 334 (step S85). Note that the relay 332 is turned off By so doing, in the discharge mode, the step-up converter 310 is electrically connected to the inverter 240, and electric power stepped up by the step-up converter 310 is supplied to the inverter 240.

Then, when it is determined in step S120 that the mismatch between the resonance coils 150 and 210 is smaller than the threshold, the step-up converter 310 and the inverter 240 are driven and electric power is transferred from the resonance coil 210 to the power transmitting device 100 in step S140.

As described above, according to this second embodiment as well, similar advantageous effects to those of the first embodiment are obtained. Then, in this second embodiment, in the vehicle 200A, in the discharge mode, electric power stepped up by the step-up converter 310 is supplied to the inverter 240, and is transmitted from the resonance coil 210 to an outside. Thus, according to this second embodiment, further high-efficiency power transfer may be achieved.

In addition, according to this second embodiment, in the discharge mode, the drive step-up converter 310 is used to step up the output voltage of the electrical storage device 260, so an increase in cost of the vehicle 200A may be suppressed.

In the second embodiment, the drive step-up converter 310 is used as a device for stepping up the output voltage of the electrical storage device 260 and then supplying the stepped up voltage to the inverter 240 when electric power is transmitted from the vehicle to an outside; whereas, in a third embodiment described below, a voltage converter is additionally provided.

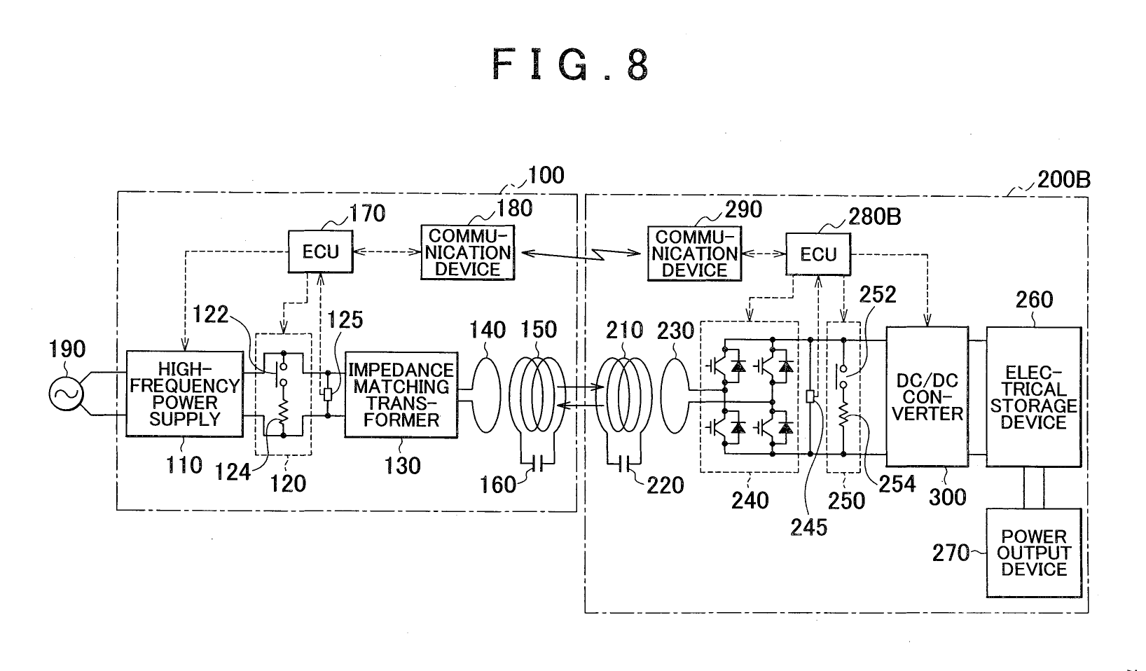

FIG. 8 is an overall configuration diagram of a contactless power transfer system according to the third embodiment. As shown in FIG. 8, a vehicle 200B in this contactless power transfer system differs from the vehicle 200 shown in FIG. 1 in that a DC/DC converter 300 is further provided and an ECU 280B is provided instead of the ECU 280.

The DC/DC converter 300 is configured to be able to convert voltage bidirectionally. When electric power is transmitted from the power transmitting device 100 to the vehicle 200B (in the charge mode), the DC/DC converter 300 further converts electric power, converted by the inverter 240 into direct-current power, to the voltage level of the electrical storage device 260 and then outputs the converted electric power to the electrical storage device 260. In addition, when electric power is transmitted from the vehicle 200B to the power transmitting device 100 (in the discharge mode), the DC/DC converter 300 adjusts (steps up) direct-current power, supplied from the electrical storage device 260 or the power output device 270, to a desired voltage and then supplies the adjusted direct-current power to the inverter 240.

When the mismatch between the resonance coils 150 and 210 is smaller than the predetermined threshold, the ECU 280B drives the inverter 240 and the DC/DC converter 300. Specifically, in the charge mode, the ECU 280B drives the inverter 240, and drives the DC/DC converter 300 so as to convert electric power, output from the inverter 240, into the voltage level of the electrical storage device 260 and then output the converted electric power to the electrical storage device 260. In addition, in the discharge mode, the ECU 280B drives the DC/DC converter 300 so as to step up electric power, supplied from the electrical storage device 260, and to supply the stepped up electric power to the inverter 240, and drives the inverter 240.

Note that the other functions of the ECU 280B are the same as those of the ECU 280 according to the first embodiment. In addition, the other configuration of the vehicle 200B is the same as that of the vehicle 200 according to the first embodiment.

As described above, according to this third embodiment as well, similar advantageous effects to those of the first embodiment are obtained. Then, according to this third embodiment, the DC/DC converter 300 is provided between the inverter 240 and the electrical storage device 260 in the vehicle 200B, so high-efficiency power transfer may be achieved as in the case of the second embodiment.

Note that, in the above described embodiments, in the method of detecting the mismatch between the resonance coils 150 and 210, the resistive circuits 250 and 120 for detecting the mismatch are respectively provided for the vehicle 200 (200A, 200B) and the power transmitting device 100, and the mismatch is detected on the basis of a receiving condition at the time when regulating electric power is transmitted; instead, the mismatch may be detected by another method. For example, a distance sensor, or the like, for directly detecting the mismatch between the resonance coils 150 and 210 may be additionally provided to thereby detect the mismatch.

In addition, in the above description, the pair of resonance coils 150 and 210 are used to transfer electric power between the power transmitting device 100 and the vehicle 200 (200A, 200B); however, a rod-shaped antenna or a fish-bone antenna may be used or a high dielectric constant disk formed of a high dielectric constant material may be used instead of the coil-shaped resonance coils 150 and 210.

In addition, in the above description, electric power is transferred between the power transmitting device 100 and the vehicle 200 (200A, 200B); however, the aspect of the invention may be applied to a device other than a vehicle, such as a mobile device and a household electric appliance, having a resonator.

Note that, in the above description, the resonance coil 210 corresponds to one example of a “power receiving resonator” in the aspect of the invention, and the step-up converter 310 or the DC/DC converter 300 corresponds to one example of a “converter” in the aspect of the invention. In addition, the step-up converter 310 corresponds to one example of a “drive converter” in the aspect of the invention, and the relay 334 corresponds to one example of a “connection device” in the aspect of the invention. Furthermore, the resonance coil 150 corresponds to one example of a “power transmitting resonator” in the aspect of the invention, and the resistive circuit 120 corresponds to one example of a “resistive circuit” in the aspect of the invention.

The embodiments described above are illustrative and not restrictive in all respects. The scope of the invention is defined by the appended claims rather than the above description. The scope of the invention is intended to encompass all modifications within the scope of the appended claims and equivalents thereof.

1. A contactless power receiving device configured to receive electric power output from a power transmitting device in a noncontact manner, comprising:
a power receiving resonator configured to resonate with a power transmitting resonator of the power transmitting device via an electromagnetic field to thereby receive alternating-current power output from the power transmitting resonator in a noncontact manner; and
an inverter configured to convert the alternating-current power, received by the power receiving resonator, to direct-current power, the inverter being configured to output the direct-current power to a power line, the inverter being configured to convert direct-current power received from the power line to alternating-current power in order to output electric power from the power receiving resonator to an outside and the inverter being configured to output the alternating-current power to the power receiving resonator.

2. The contactless power receiving device according to claim 1, further comprising:
a direct-current power supply; and
a converter connected between the direct-current power supply and the power line, the converter being configured to adjust a voltage of the power line.

3. The contactless power receiving device according to claim 2, wherein
the contactless power receiving device is mounted on an electric vehicle that travels using an electric motor,
the converter is a drive converter provided between the direct-current power supply and a driving device of the electric motor, and
the contactless power receiving device further includes a connection device configured to be used to electrically connect the drive converter to the power line when electric power is output from the power receiving resonator.

4. The contactless power receiving device according to claim 2, further comprising:
controller configured to detect a mismatch between the power transmitting resonator and the power receiving resonator on the basis of a transfer condition of electric power between the power transmitting resonator and the power receiving resonator, the controller being configured to drive the inverter and the converter when the mismatch falls within a predetermined range set on the basis of the transfer condition.

5. The contactless power receiving device according to claim 4, wherein
the controller is configured to control the inverter and the converter on the basis of an amount of the mismatch.

6. The contactless power receiving device according to claim 1, further comprising:
controller configured to detect a mismatch between the power transmitting resonator and the power receiving resonator on the basis of a transfer condition of electric power between the power transmitting resonator and the power receiving resonator, the controller being configured to drive the inverter when the mismatch falls within a predetermined range set on the basis of the transfer condition.

7. A vehicle comprising:
the contactless power receiving device according to claim 1.

8. A contactless power transmitting device configured to output electric power to a power receiving device in a noncontact manner, comprising:
a power supplier configured to generate alternating-current power having a predetermined frequency;
a power transmitting resonator configured to resonate with a power receiving resonator of the power receiving device via an electromagnetic field to thereby output the alternating-current power supplied from the power supplier to the power receiving resonator in a noncontact manner; and
a resistive circuit provided between a pair of power lines connected between the power supplier and the power transmitting resonator, the resistive circuit being configured to be electrically connected between the pair of power lines at the time of detection of a mismatch between the power transmitting resonator and the power receiving resonator, and the detection of the mismatch being carried out when the power transmitting resonator receives electric power output from the power receiving resonator.

9. The contactless power transmitting device according to claim 8, wherein
the resistive circuit includes a resistor having a set resistance value and a relay connected in series with the resistor, relay being configured to enter an electrically conductive state at the time of detection of the mismatch.

10. A contactless power transfer system configured to transfer electric power in a noncontact manner, comprising
a power transmitting device including a power supplier configured to generate alternating-current power having a predetermined frequency and a power transmitting resonator configured to output the alternating-current power supplied from the power supplier in a noncontact manner, and
a power receiving device including a power receiving resonator configured to resonate with the power transmitting resonator via an electromagnetic field to thereby receive the alternating-current power output from the power transmitting resonator in a noncontact manner, the power receiving device including an inverter configured to convert the alternating-current power received by the power receiving resonator to direct-current power, the inverter configured to output the direct-current power to a power line, the inverter being configured to convert direct-current power received from the power line to alternating-current power in order to output electric power from the power receiving resonator to an outside, and the inverter being configured to output the alternating-current power to the power receiving resonator.

11. The contactless power transfer system according to claim 10, wherein
the power receiving device further includes a direct-current power supply and a converter connected between the direct-current power supply and the power line, the converter being configure to adjust a voltage of the power line.

12. The contactless power transfer system according to claim 11, wherein
the power receiving device is mounted on an electric vehicle that travels using an electric motor,
the converter is a drive converter provided between the direct-current power supply and a driving device of the electric motor, and
the power receiving device further includes a connection device configured to be used to electrically connect the drive converter to the power line when electric power is output from the power receiving resonator.

13. The contactless power transfer system according to claim 10, wherein
the power transmitting device further includes a resistive circuit provided between a pair of power lines connected between the power supplier and the power transmitting resonator, the resistive circuit being configured to be electrically connected between the pair of power lines at the time of detection of a mismatch between the power transmitting resonator and the power receiving resonator, and the detection of the mismatch being carried out when the power transmitting resonator receives electric power output from the power receiving resonator.

14. The contactless power transfer system according to claim 13, wherein
the resistive circuit includes a resistor having a set resistance value and a relay connected in series with the resistor, the relay entering an electrically conductive state at the time of detection of the mismatch.
